(19) United States
(12) Patent Application Publication
(10) Pub. No.: US 2007/0220754 A1
(43) Pub. Date: Sep. 27, 2007

(54) Counter apparatus and method for consumables

(76) Inventors: Jennifer Barbaro, Huntington Beach, CA (US); Bruce Roeland, Huntington Beach, CA (US)

Correspondence Address: Terry L. Miller;Law Office of Terry L. Miller, 24832 Via San Fernando, Mission Viejo, CA, 92692, US

(21) Appl. No.: 11/364,954

(22) Filed: Mar. 1, 2006

(51) Int. Cl. B26B 19/44

(52) U.S. Cl. 30/41

(57) ABSTRACT

A self-learning counter apparatus and method for consumables is effective to learn a user's schedule for consuming items, such a pills or medicines; or to learn the useful life of a consumable or wearing item, such as a razor blade or toothbrush. Subsequently, during a reminder mode of operation, the device reminds the user to take a pill, or reminds the user when the useful life of the item (such as a razor blade or toothbrush) is at an end, so that the item can be replaced in a timely fashion. One useful embodiment of the invention learns and then signals a user that the useful life of a safety razor blade has ended. Another useful embodiment of the invention learns and then reminds a user that the useful life of a toothbrush or power toothbrush head is at an end. Still another useful embodiment of the invention learns and then reminds a user of the user's pill or medicine taking schedule.

### FIELD OF THE INVENTION

The present invention generally relates to a counter apparatus and method for consumables. More particularly, the present invention relates to a counter and reminder apparatus and method which serves to remind a user when a consumable item is to be used or consumed, or when such a consumable item has been used to the extent that it is worn out and should be replaced. By way of example, this invention may find application as a usage counter for safety razors. Alternatively, the present invention may be embodied as a reminder and counter for medications, particularly for pills. Still alternatively, this invention may find use as a counter and reminder for a toothbrush or for the brush head of an automatic toothbrush, for reminding a user of when the brush or brush head is to be replaced.

### BACKGROUND OF THE INVENTION

Continued use of a razor results in the razor blade becoming dull. Shaving with a dull razor requires the application of greater force than is required with a sharp razor, results in a poor shave, and tends to nick the face. Therefore, it is desirable to change the blade in a safety razor before it becomes sufficiently dull to cause these problems. The number of times that a razor blade can be used before becoming too dull for safe use varies with the brand of the razor and/or blade, and with the skin and beard of the particular user. Thus, the number of safe uses of a razor blade is personal to the individual. Though the number of safe uses of a razor blade can be determined through experience, maintaining in memory an accurate, ongoing count of the number of uses of a particular razor blade is difficult, if not impossible.

Therefore, there is a need in the art for automatic shave counting means to indicate when a razor blade is too dull for safe use.

A similar analysis applies to the use of a toothbrush, or to the brush head of an automatic (i.e., powered) toothbrush. A worn brush or brush head results in less than optimum cleaning of the teeth. However, a user may not be aware of this deficient cleaning of their teeth until the next dentist visit results in an unfavorable visit and an instruction to brush better. Brushing better may simply involve buying a new brush head for the power toothbrush. That is, the problem may not be that the user needs to brush any differently, but just needs a new and more effective toothbrush or brush head for their powered toothbrush.

One power tooth brush company (Braun®) has provided a brush use measuring system into a top-of-the-line power tooth brush. But, this system is believed to simply measure the time duration of brush use, and is specific to the particular power tooth brush model and to the brush heads for that model. That is, a user of another brand, or of another model of power tooth brush cannot benefit from the brush head reminder built into that particular power tooth brush.

Another instance in which a user of a consumable item needs a reminder to use the item, or a counter to indicate when and how many times an item has been used is in the field of medications, particularly pills. Many people take daily medication pills, and some take medication pills twice, or three times, or more often per day. Conventionally, a consumer receives pills from a drug store in a pill bottle, and in order to keep track of if and when these pills are to be taken, the pills are transferred to the recesses of a pill reminder tray. These pill reminder trays are made in several varieties, providing for the pills to be scheduled once, twice or perhaps three times per day. That is, these pill trays usually sub-divided into recesses corresponding to the days of the week, with one, two, or perhaps three recesses (i.e., AM, mid-day, and PM) for each day of the week.

A distinct disadvantage of the use of such pill reminder trays it that the user must transfer the pills from the pill bottle into the appropriate recess of the reminder tray. This is tedious, and presents the risks of error, as well as a risk that pills will be dropped and lost, damaged, or soiled.

With respect to safety razors, various shave counting means have been disclosed in the prior art. These prior art shave counters are generally constructed as a rack having plural locations for storage of the razor, such that the user advances the razor along the rack one location for each use. Thus, the user can judge how many shaves a razor blade is good for. But, this system doesn't maintain an indication of where the razor was before the current use, so during a shave a user can forget where the razor was and lose track of the count. Some other varieties of the conventional technology have the shave counting means formed in the structure of the razor. This limits the user's choices of blades to particular razor brands. So, a razor holder that includes shave counting means permits the use of a wide variety of razors and therefore is preferred.

An exemplary prior art razor including shave counting means is disclosed in U.S. Pat. No. 3,476,077 to Henkel wherein an indexing disk is disposed in the handle of the razor and is rotated by the user after each shave.

U.S. Pat. No. 3,618,563 to Singer discloses a safety razor with shave counting means disposed in the razor handle that is likewise manually operated after each use.

U.S. Pat. No. 4,112,271 to Marchetti discloses an electric shaver having counting means controlled by the operation of the shaver on/off switch.

A blade shave counter is disclosed by U.S. Pat. No. 5,347,715 to Friedland.

U.S. Pat. No. 5,240,107 to Casale discloses a razor holder for a safety razor, in which a counter is advanced each time the razor is used. This razor holder does not appear to be water resistant or water proof, and does not learn the useful life of a razor blade for a particular user.

### SUMMARY OF THE INVENTION

An object for this invention is to overcome or ameliorate one or more of the deficiencies of the conventional technology.

The present invention provides a reminder and counter for a consumable item, such as a pill or pills to be taken, a tooth brush or power toothbrush head that has a finite life, or a safety razor (or razor cartridge) which dulls with use until it is time to replace the safety razor.

The razor use reminder is preferably configured as a razor holder which will accept a wide variety of brands and styles of safety razors. A body of the razor holder includes a nest or receptacle for the safety razor, and a sensor first element is associated with this nest to detect when the razor is removed from and replaced into the nest. A non-contact water-proof sensor second element provides an input to a counter device disposed inside of the razor holder body, so that the counter device is isolated from water and the wet environment which is likely to exist in a bathroom or shower room for example. The counter has a learning phase of operation during which it learns the useful life of a razor blade for a particular user, and a reminder phase of operation during which it counts down the useful life of successive razor blades, and reminds a user when the end of life has been reached for a particular blade so that the blade can be replaced by the user.

The toothbrush use reminder includes a brush or brush head holder which will accept a particular brand or style of brush head, or a manual toothbrush, for example. The holder may alternatively be configured to accept another brand or style of brush head. In the one case in which the brush head includes drive magnets, these drive magnets are employed as a first element of a non-contact water-proof sensor for determining when the brush head is used. In the case of a manual tooth brush, or power tooth brush head which does not use drive magnets, the toothbrush or brush head may have a magnet added, or the holder may itself include a moving first element of a non-contact, waterproof sensor for indicating when the toothbrush or brush head is used.

A pill use reminder embodying the present invention similarly includes a holder for standard sizes of pill bottles, and indicates to the user of the device when the pill bottle has been removed from the holder for the purpose of the user taking a pill or pills. An audible and/or visible reminder may be included in this embodiment to signal the user when it is next time to take a pill.

These and other objects and advantages of the present invention will be apparent to those skilled in the art from the following description of preferred embodiments, claims and appended drawings.

### BRIEF DESCRIPTION OF THE DRAWING FIGURES

FIG. 1 is a perspective view of a first preferred embodiment of the invention, which is configured as a razor holder and is seen in a first configuration preparatory to receiving a safety razor;

FIG. 2 is a perspective view of the first embodiment in a second configuration with the safety razor received in the razor holder;

FIGS. 3 and 4 are respective fragmentary cross sectional views of the embodiment seen in FIGS. 1 and 2, and illustrate movements of a first sensor portion of the razor holder dependent upon placement into or removal from the razor holder of a safety razor;

FIG. 5 is a rear elevation view of the safety razor holder seen in FIGS. 1-4;

FIG. 6 is an exploded perspective view of the safety razor holder seen in FIGS. 1-5;

FIG. 7 is a fragmentary cross sectional view of a portion of the razor holder seen in FIGS. 1-6;

FIGS. 8 and 9, respectively, are a front and side elevation views, each partially in cross section, of a holder for a tooth brush (or power tooth brush head) embodying the present invention;

FIG. 9A is a side elevation view similar to FIG. 9, but showing an alternative embodiment of the invention;

FIGS. 10, 11, and 11A, respectively, are a front elevation view, a fragmentary cross sectional view (both partially in cross section), and a fragmentary plan view, of a pill bottle holder (and pill use reminder) embodying the present invention; and

FIG. 12 is an exemplary flow chart for a controller function (i.e., for a learning mode, and for a reminder mode of operation) of the present invention.

### DETAILED DESCRIPTION OF THE EXEMPLARY PREFERRED EMBODIMENTS

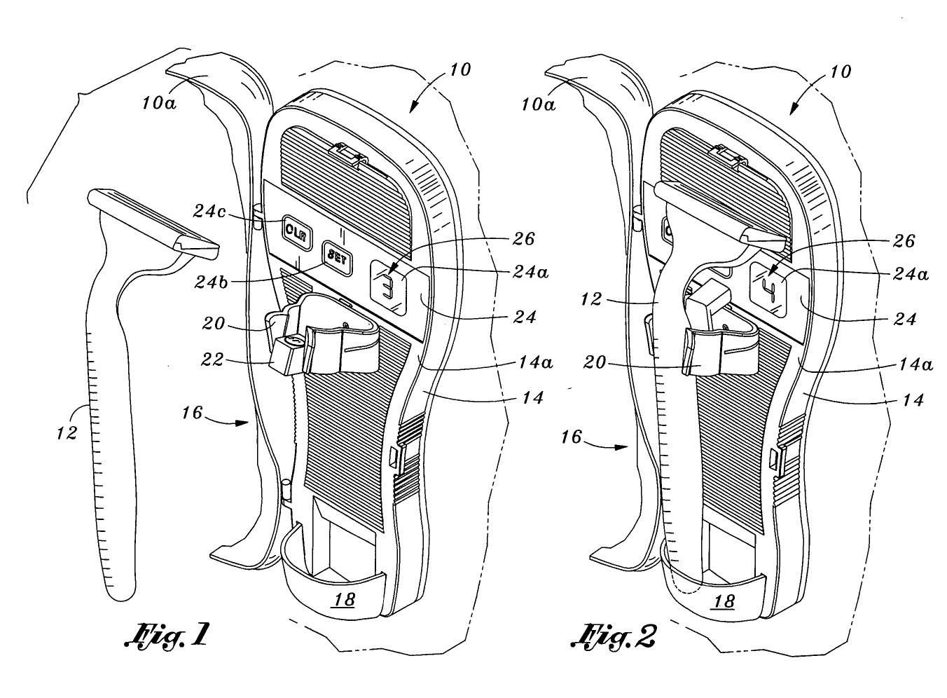

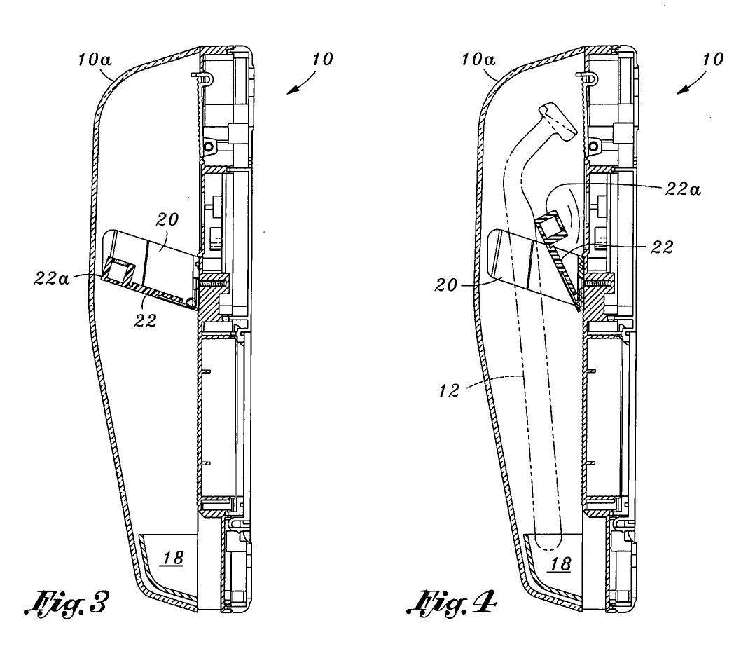

FIGS. 1 and 2 each illustrate in a three-quarter front perspective view a first preferred embodiment of the invention, which is configured as a razor holder 10. In FIG. 1, a cover 10a of the razor holder 10 is open preparatory to a safety razor 12 being received into the holder 10. This razor will be enclosed cooperatively by a base portion 14 and a pivoted or hinged cover portion 10a (best seen in FIG. 6) of the razor holder 10. As can be seen in FIGS. 1 and 2, the base portion 14 defines a recess or nest, indicated with the arrowed numeral 16, into which the safety razor 12 may be received. This nest 16 includes a lower pocket structure 18, and an upper bracket or stirrup 20 which receive the handle of the safety razor 12, as is illustrated in FIGS. 1 and 2.

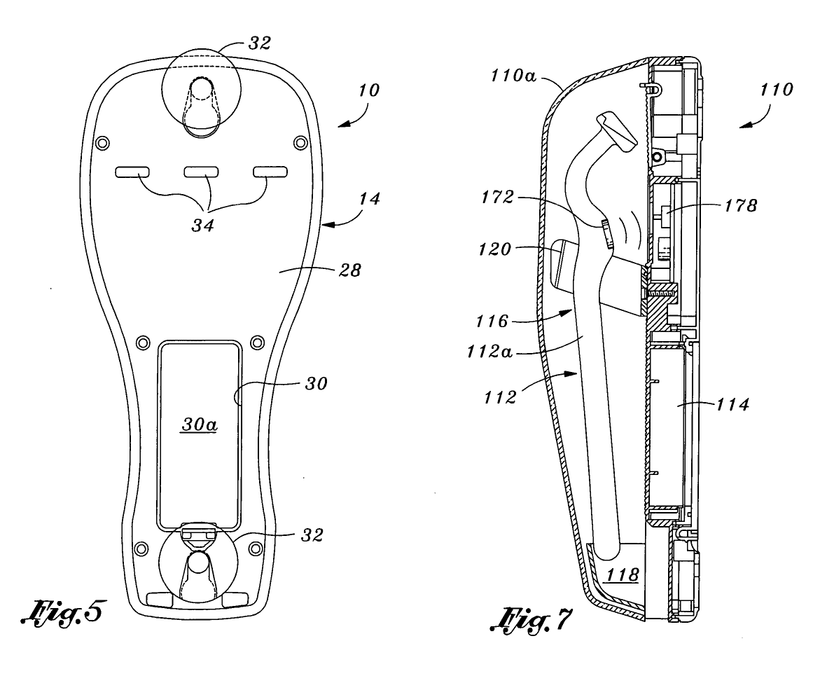

The bracket 20 includes a pair of spaced apart protruding legs 20a. As is also seen in these Figures, the head or razor cartridge 12a of the safety razor 12 is disposed immediately above the bracket 20 when the razor is disposed on the base 14 (viewing FIG. 2). FIG. 4 illustrates that an arm member 22 disposed pivotally between the legs 18a is pivoted by contact with the razor handle to a position in which the distal end 22a of this arm is proximate to a front panel 14a of the base portion 14. In contrast, FIGS. 1 and 3 show that when the razor 12 is removed from the nest 16, the arm 22 at its distal end portion 22a is pivoted away from the front panel 14a of base portion 14.

Further considering FIGS. 1 and 2, it is seen that the front panel 14 sealingly carries a flexible and partially transparent diaphragm member 24. This diaphragm member 24 defines a transparent window portion 24a at which may be seen characters 26 provided by a display (to be further described below) disposed within the base portion 14. Also, this diaphragm portion 24 defines a pair of flexible portions 24b and 24c, which each serve as a tactile area (i.e., a push pad) for effecting a user input to a microprocessor based controller (also to be further described below) which is also disposed within the base portion 14.

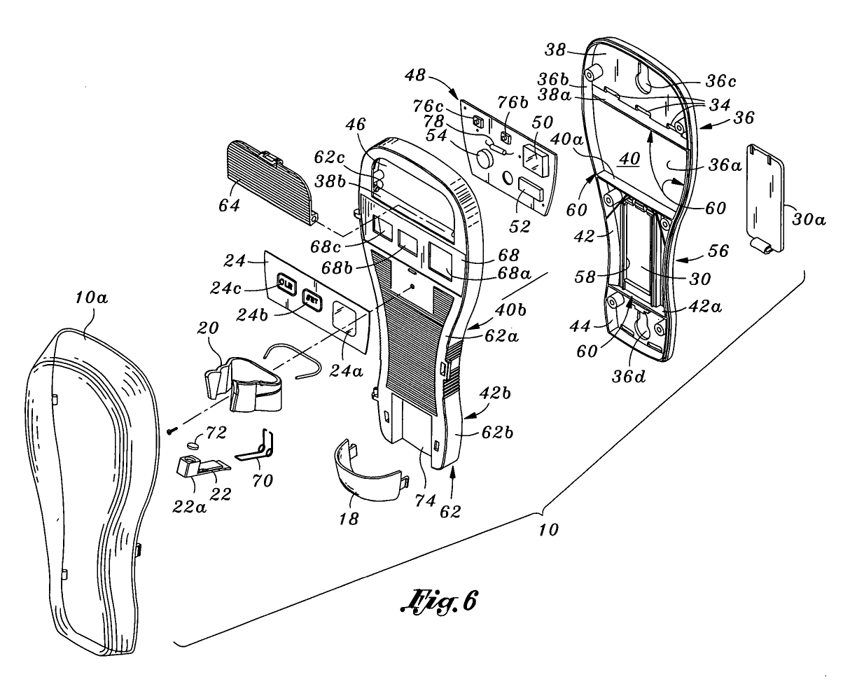

Considering FIG. 5 briefly, it is seen that the base portion 14 has a rear surface 28 provided with a door opening 30 sealingly receiving a door member 30a closing a battery compartment (to be further described below). Also carried optionally on the rear surface 28 is a pair of suction cups 32, which provide for the razor holder 10 to be mounted to a shower room wall, or to a mirror, for example. Also, opening outwardly through the surface 28 is a number of water drainage openings 34 providing for draining of a razor head storage compartment (to be further described below) located within an upper portion of the base 14.

Turning now detailed attention to FIG. 6, an exploded perspective view of the razor holder 10 is provided. It is seen first of all that the base portion 14 is comprised of a plurality of component parts, many of which are injection molded plastic, providing for ease and economy of manufacture, as well as water-resistant durability for the razor holder 10. Considering first of all an injection molded back wall component 36, it is seen that this component includes a back wall portion 36a outwardly defining the rear surface 28, and a peripheral wall portion 36b which in cooperation with the wall portion 36a inwardly bounds four cavities or recesses 38, 40, 42, and 44. The upper cavity 38 will be seen to form a part of a razor head storage cavity, indicated on FIG. 6 with the arrowed numeral 46. The drain openings 34 extend outwardly from adjacent the lower extent of this cavity 46. Also, the wall portion 36a defines a key-hole shaped opening 36c for securing the upper one of the suction cups 32. A partition portion 38a sealingly bounds the lower extent of the cavity 38.

The cavity 40 provides part of the volume needed to accept and sealingly enclose a circuit board 48, which carries a display 50, processor 52, and auditory signaling device 54 (i.e., a buzzer or beeper). The display 50 is preferably a one and one-half (1½) digit LED display (i.e., a two-character display, with the right-most character having eight segments illuminated controllably to form any numeral between 0 and 9. This character is also able to form selected alphabetical characters, such as “S” and “P” the significance of which will be explained below. The left-most character is composed of two segments, which are either both off (i.e., dark) or both on (i.e., illuminated). Thus, the left-most character is either dark, or displays a one (1). As will be further explained, the circuit on board 48 operates to allow it to be programmed first by use of the razor 12 with a particular brand of razor blade, to record that usage level, and then later to remind the user when to change successive blades on an on-going basis based on the first usage experience, and that first measured use of a particular brand of razor blade.

A partition portion 40a bounds the lower extent of the cavity 40. Cavity 42 provides a part of the volume needed for a battery compartment (indicated on FIG. 6 with arrowed numeral 56. The wall component 36 also defines the door opening 30 leading to this battery compartment 56, and carries a sealing element (indicated by arrowed numeral 58) circumscribing the door opening 30. A partition portion 42a sealingly bounds the lower extent of the cavity 42. And finally, the cavity 44 provides space near the bottom of the base portion at which the wall portion 36a defines another key-hole opening 36d for securing the lower one of the suction cups 32.

In order to sealingly protect both the battery compartment 56 and the circuit board 48, the wall portion 36 carries a sealing element (indicated by arrowed numeral 60). This sealing element 60 extends across the partition portions 38a and 42a, and circumscribes the cavities 40 and 42 (i.e., along peripheral wall 36b) to circumscribe both the circuit board 48 and the battery compartment 56.

Considering the injection molded front wall component 62, it is seen that this component includes a front wall portion 62a, and a circumscribing peripheral wall portion 62b. The front wall component 62, similarly to the rear wall component 36, includes partition portions 38b, 40b, and 42b (portions 40b and 42b not being seen in the drawing Figures but indicated with arrowed numerals on FIG. 6). These partition portions confront the partition portions 38a, 40a, and 42a of the rear wall component 36. Thus, the sealing element 60 sealingly engages the portion of peripheral wall 62b circumscribing the cavities 40 and 42, and also sealingly engages the partition portions 38b and 42b.

The front wall portion 62a defines a doorway 62c, and a door member 64 is receivable into this door way to close a razor blade storage cavity 46, which includes the cavity 38. Below the doorway 62c, the front wall portion 62a also defines a transverse groove 68, having openings 68a, 68b, and 68c thereon. The flexible diaphragm member 24 is sealingly received into groove 68, and the window portions 24a/b/c align with openings 68a/b/c.

Carried on the front wall portion 62a is bracket member 20 which pivotally carries arm 22, along with a spring member 70 yieldably biasing the arm 22 to an outward pivoted position. The distal end portion 22a of arm 22 carries a small button magnet 72. Finally, the lower part of front wall portion 62a defines a recess 74, and the pocket member 18 attaches at and spans across this recess 74. Thus, the recess 74 provides a drain opening from the pocket 18. Finally, it is seen that the front cover 10a hingeably attaches to the front wall component 62.

Turning now to further consideration of the circuit board 48, it is seen that in addition to the display 50, processor 52, and audio output device 54, this circuit board carries a pair of protruding momentary-contact push-button switches 76b, 76c, which are respectively aligned with and protrude partially through the openings 68b/c. Thus, the flexible portions 24b/c of diaphragm 24 serve as push buttons for effecting manual actuation of the switches 76b/c, respectively The display 50 is aligned with opening 68a, and can be seen through window portion 24a of the diaphragm member 24.

Additionally, this circuit board 48 carries a magnetically-responsive switch 78, which is disposed on the front side of the circuit board, is aligned generally in the center of this circuit board, and thus is aligned generally with the button magnet 72 carried at the distal end 22a of arm 22 when this arm is in the position seen in FIGS. 2 and 4. Most preferably, the switch 78 is embodied in a magnetically-responsive reed switch, although other types of magnetically responsive switching devices may be employed. The reed switch has the advantage of being all of inexpensive, reliable, and rugged. Such a reed switch is normally-open, but is magnetic (i.e., is responsive to the presence of a magnetic field) to close). So, the switch 78 is activated when the razor 12 is in nest 16 to provide a contact closure input (CCI) to the circuit on circuit board 48. In contrast, when arm 22 is in the position seen in FIGS. 2 and 4 (indicating that the razor 12 has been removed from nest 16 by a user) the switch 78 is de-activated.

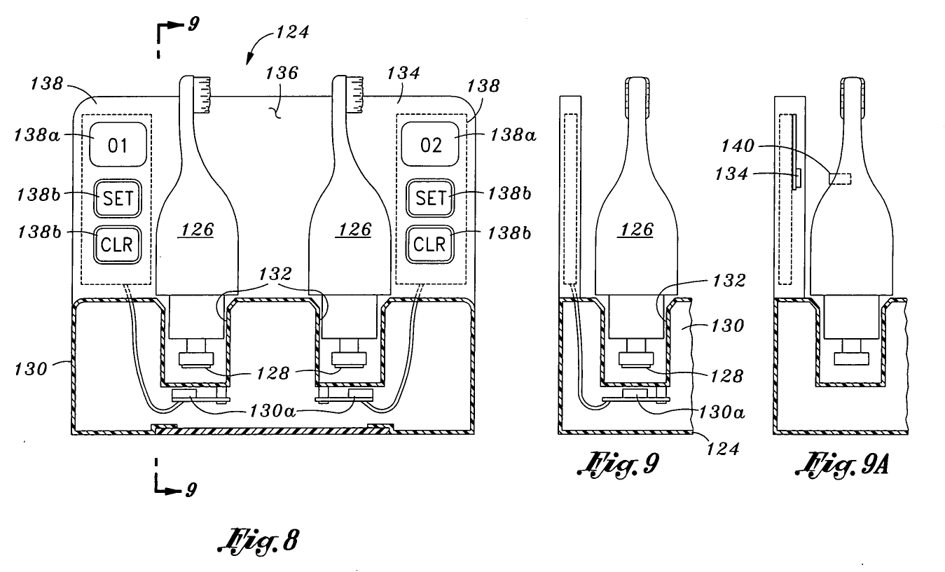

Turning now to FIG. 7, an alternative embodiment of the invention is illustrated in fragmentary cross sectional view. Because the embodiment of FIG. 7 shares many features with the first embodiment of FIGS. 1-6, features of FIG. 7 which are the same as, or which are equivalent in structure or function to a feature of FIGS. 1-6, are indicated on FIG. 7 with the same numeral used above, and increased by one-hundred (100). That is, the embodiment of FIG. 7 depicts a razor holder 110 having a base portion 114 hingeably carrying a cover 110a, and also carrying a razor nest 116. The razor pocket 116 includes a pocket 118 disposed below a razor holder bracket 120. However, the embodiment of FIG. 7 does not include a pivoted arm 22 or magnet 72 as was disclosed with respect to the first embodiment of FIGS. 1-6. In contrast, the embodiment of FIG. 7 utilizes a safety razor 112 having embedded in the shank 112a of the safety razor 112 a small button magnet 172. Thus, when the razor 112 is placed into the nest 116, the magnet 172 activates the magnetically responsive switch 178 (indicated by the arrowed numeral on FIG. 7).

Having observed the structure of the razor holder 10, attention may now be directed to its operation. For this purpose, attention now to FIG. 12 along with the following description will be helpful. When a user places batteries into the battery holder 56, the circuit on circuit board 48 powers on, as is indicated at 80. Display 50 will display and blink a “P” character (standing for “program”) for three seconds, as is indicated at 82. At this time, the circuit 48 waits for a user to place a razor with a fresh razor blade into the next 16, which closes the magnetic switch 78 (referred to as CCI1—for contact closure input 1) indicated at 84. The circuit 48 sets a variable “N” to the value of zero (0) and displays this value, as is indicated at 86 and 88 on FIG. 12.

Next, when the user takes the razor out of nest 16 for a first shave, CCI1 goes open, as is indicated at 90. The circuit 48 increments the value of “N” upward by one, and displays this value (blinking) for a determined time interval (indicated at 92 and 94 on FIG. 12). When the user finishes the shave and replaces the razor into nest 16, the CCI1 goes closed, indicated at 96 on FIG. 12. If the CCI2 (i.e., activated by the SET button, switch 76a) is not closed (see decision diamond 98 on FIG. 12), then the circuit 48 returns to 90 to await the next shave event. Thus, for each good shave of this first razor blade, the circuit 48 counts up the shaves and stores this value as “N*” (i.e., a durable value of N).

On the other hand, during this programming experience, when the user first notices that the razor blade is going dull, and before the razor blade becomes definitely dull, the user presses and holds the SET button at the completion of a shave, as is indicated on FIG. 12 at 98. This event causes the circuit 48 to display “S” (indicating that it is now SET—event 100 on FIG. 12), to leave the programming loop just explained, and to utilize the value of “N*” as a starting value in future shave counting sequences for the user (indicated at 102, 104 on FIG. 12). At this time, the user places a new razor blade into the razor, and places the razor into the nest 16.

When next the user removes the razor from nest 16 to shave, the CCI1 goes open (106 on FIG. 12), and the value of N (which was initially set at N*) is decreased by one (1) and displayed to the user (108 and 110 on FIG. 12). This tells the user how many good shaves can be expected from the razor blade. If the value of N is not zero (112 on FIG. 12), and when the shave is completed (114 on FIG. 12) when the user places the razor back into the nest 16, the circuit 48 returns to condition 106 waiting for the next shaving event.

However, in the event that a sufficient number of shaves have been performed with a particular razor blade, the number “N” will have reached zero (0), in that event, the user is warned that no additional good shaves can be expected from that razor blade. This warning is effected by use of the beeper 54 to sound an alarm (indicated at 116 on FIG. 12), and by the display 50 showing a “C” character (standing for CHANGE the razor blade) indicated at 118 on FIG. 12. When the user changes the razor blade, and presses the CLR button, CCI2 goes closed (120 on FIG. 12), then when the user places the razor with a fresh blade back into nest 16, the CCI1 goes closed (122 on FIG. 12), and the circuit 48 returns to condition 104 at which the value of N* is recalled and set as the value N for the next shaving sequence with the new razor blade.

Stated again, the methodology of operation for the razor holder 10, and particularly, for the processor-based circuit on board 48, first effects programming of this circuit by use of a razor until the user just detects that the razor blade is going dull. During this programming experience, the user can be diligent, and aware of the quality of shave being experienced on each occasion. When the blade first appears to be going dull, and before it begins to give a bad shave, the user presses the “S” button storing the number of good shaves experienced with that brand and model of razor blade for future reference (i.e., as the value N*). The user then changes the razor blade, and thereafter during the life of that particular razor blade each time a shave event takes place, the razor holder senses this shave event and counts down the number of good shaves remaining. When the number of good shaves to be expected reaches zero (0), then the razor holder 10 signals the user to change the razor blade.

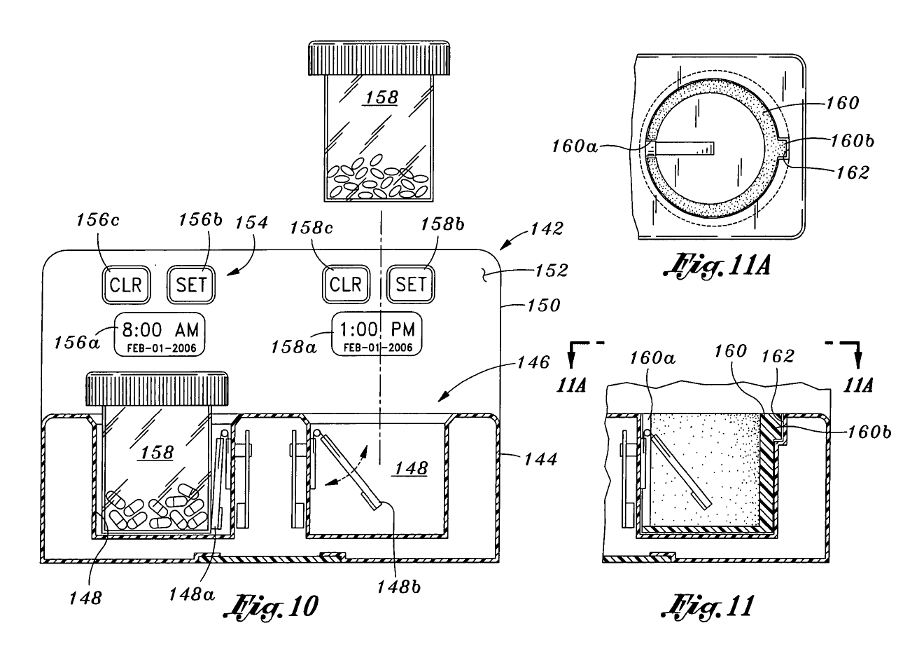

Turning now to FIGS. 8 and 9 in conjunction to one another, these Figures depict a holder 124 specifically configured in the first instance to receive and hold a brush head 126 of the type utilized by the Phillips® Sonicare® powered tooth brush. Because the Sonicare® toothbrush utilizes a magnetic drive of the brush head, and includes a pair of magnets (indicated by arrowed numeral 128), these magnets may be utilized to sense when the brush head 126 is removed by a user from the holder 126 for tooth brushing. Thus, the number of times the tooth brush head 126 is removed from the holder 124 for use before it becomes sufficiently worn that it should be replaced can be tracked by the holder 124 in the same way that razor use was tracked by the first and second embodiments of FIGS. 1-6, and FIG. 7, respectively. More particularly, the holder 124 includes a base 130 defining a pair of receptacles 132 each for receiving the lower portion of a respective one of a pair of brush heads 126. Base 130 supports a back portion 134 providing a surface 136 upon which is disposed a water proof diaphragm 138. This diaphragm 138 provides a pair or display windows 138a, and a pair of pushbutton areas 138b/138c, which displays are respectively utilized to indicate the number of uses remaining for a corresponding one of a pair of brush heads to be stored in the receptacles 130. The push buttons are utilized as was explained above to program and then to reset the brush holder 124 much as has been described with respect to the razor holder 10.

As FIG. 8 discloses, the holder 124 at base portion 130 includes a pair of magnetic sensors 130a (i.e., magnetic switches) which respectively close and open dependent upon the presence or absence of the toothbrush head relative to a respective one of the receptacles 132. Accordingly, as with the razor holder 10, the toothbrush holder 124 is able to count and provide an indication to a user (or a pair of users) of the number of uses remaining for a particular toothbrush head before that toothbrush head should be replaced.

FIG. 9A illustrates an alternative embodiment of a brush head holder very similar to the one depicted in FIGS. 8 and 9. For this reason, the features are indicated on FIG. 9A with the same numeral used previously, and having a suffix “a” added thereto. Considering now FIG. 9A, it is indicates by dashed lines 140 that the brush head of a power toothbrush may alternatively be provided in the alternative with an embedded magnet (much as was the case with the razor illustration in FIG. 7) so that the presence or absence of the tooth brush head may be sensed by a brush head holder without use of drive magnets 128. In the case illustrated diagrammatically by dashed lines 140, the sense magnet may be embedded anywhere in the brush head that is convenient. In such an instance, the magnetically responsive switches 130aa would be disposed in the back portion 134 generally in juxtaposition to the magnets 140.

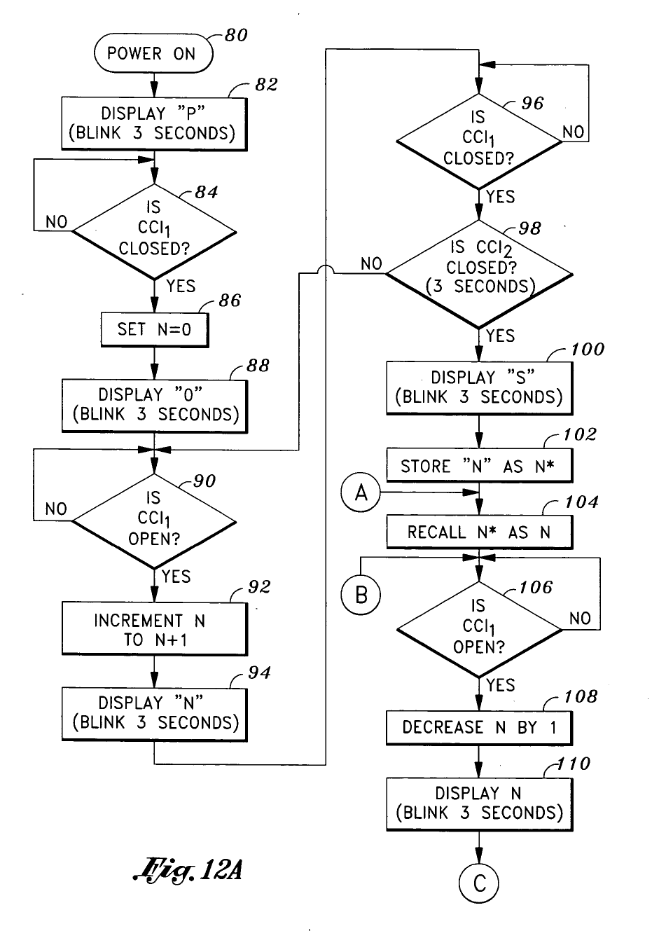

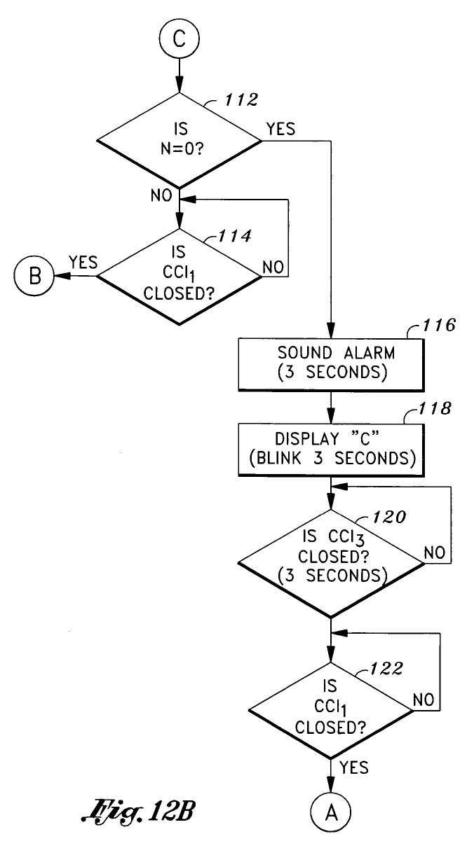

Turning now to drawing FIGS. 10, 11, and 11A in conjunction with one another, a pill bottle reminder unit 142 is illustrated. This pill reminder unit 142 includes a base portion 144 including a front portion 146 defining a pair of spaced apart receptacles, each indicated with the numeral 148. A back portion 150 is supported at the rear of the base portion 146, and provides a surface 152 upon which is disposed a water proof diaphragm 154. This diaphragm 154 provides a pair of display windows 156a/158a (i.e., each allowing a visual display disposed behind the window to be viewed by a user of the reminder unit 142), and a pair of pushbutton areas 156b/156c, 158a/158b, respectively associated with each of the display windows. These displays 156a/158a are respectively utilized to provide an indication to a user of the reminder unit 142 of when a pill was last taken, or when a pill is next to be taken, for example. The events during which a user of the reminder unit takes a pill are obtained by sensing when a user has removed a pill bottle (seen in FIG. 11) from the receptacle 148 so that the user can take a pill from the particular pill bottle. In the illustrated exemplary embodiment, each display 156a/158a is providing with a time and calendar indication. As was the case with the razor holder illustrated and described as the first embodiment of the present invention, the push buttons 156b/156c, and 158b/158c are utilized generally as was explained above to program the pill bottle reminder unit (i.e., during a learning phase of operation). That is, the user utilizes the unit 142 during a learning phase (which programs the unit) and thereafter, the unit serves as a reminder for the user to maintain the pill schedule the user has “taught” the unit 142. Further to the above, it will be appreciated that in addition to a counting function, the pill or medicine reminder has a time-keeping and calendar function. Thus, the time of day and days of the week can be tracked by the device in both the learning mode of operation, and in the reminder mode of operation.

As FIG. 10 discloses, the pill bottle reminder 142 at base portion 146 and within recesses or receptacles 148 includes a pair of magnetic sensors 148a/b (i.e., spring loaded arms each carrying a magnet—only one of which is seen in the drawing Figures). These spring loaded arms move between a first to a second position in response to insertion and removal of the pill bottle from the receptacles 148. FIG. 10 at the left side shows an exemplary pill bottle 158 in one of the receptacles 148 having moved arm 148a to its second position. At the right hand side of FIG. 10, it is also shown how the arm 148b moves to its second position which it will occupy when a user removes the pill bottle 158 from the receptacle.

FIG. 10 indicates that the receptacles 148 are able to accept and utilize the large diameter pill bottles in which some large pills (or pills in larger numbers) are dispensed by a pharmacist. On the other hand, FIGS. 11 and 11A illustrate that when pills are dispensed in smaller sized pill bottles, an eccentric bushing 160 is slipped into the receptacle 148 for the purpose of receiving the smaller pill bottle. This eccentric bushing has an opening or slot 160a along the side aligning with the arm 148a or 148b, allowing the arms 148a/b to move relative to the receptacles, responding to the insertion and removal of a pill bottles from the receptacles. In order to maintain alignment of the bushing slot 160a and the arm 148a/b, the base 146 defines key ways 162, and the bushing defines a matching key 160b receivable into these keyways. In order to facilitate the use of the pill reminder unit 142 with a variety of standard sized pill bottles, the bushings 160 are provided with the unit 142 in appropriate sizes.

Accordingly, as with the razor holder 10, and the toothbrush holder 124, the pill reminder unit 142 is able to learn the user's schedule (in this case, a pill taking schedule) during a programming or learning phase of operation, after which the reminder unit 142 repeats the learned schedule in order to remind a user to take a pill at a particular time of day, or can provide an indication that the user has already taken a pill for a particular scheduled time (i.e., in the case of absent-minded users). Importantly, the pill reminder unit 142 completely eliminates the need for a user to remove pills individually from the bottles in which they are supplied by a pharmacist, and improves both safety and cleanliness for the pills, as well as providing an audible reminder to the user of when a pill is next to be taken.

The present invention has been depicted and described by reference to particularly preferred exemplary embodiments, which reference is not implied as a limitation on the invention, and no such limitation is to be inferred. The invention is intended to be limited by the spirit and scope of the appended claims, which also provide a definition of the invention. Moreover, the invention is intended to be limited only by the following claims, giving full cognizance to equivalents in every instance.

We claim:

1. A self-learning reminder device for reminding a user of the device when a consumable item is to be consumed, or when a consumable item has been uses sufficiently that its useful life is at an end and the item should be replaced, said device comprising;
a base portion, said base portion internally defining a chamber for receiving a counting circuit, and including a display and input facility for allowing a user of the device both to receive a visual indication of consumption or use events and to input user commands to said device;
a programmable microprocessor-based circuit disposed within said chamber, and said microprocessor including programming to, on the one hand, learn during a programming mode of operation an event selected from the group comprising: the number of consumption events in a determined time interval of a user's schedule or the number of use events during a useful life of a consumable item; and
during a reminder mode of operation said programmable microprocessor-based circuit performing a respective reminder action selected from the group consisting of:
counting the number consumption events effected by the user in a subsequent determined time interval, or counting the number of use events in a subsequent useful life of a new consumable item, and
signaling the user when the next consumption event is to take place, or when the number use events has reached a learned maximum and the useful life is at an end.

2. The reminder device of claim 1 further including a water-proof sensor facility for providing a non-contact input to said counting circuit in response to a use event.

3. A water-resistant razor holder device having a shave counter, said razor holder device comprising;
a base portion, said base portion internally defining a chamber for receiving a shave counting circuit, and including a water-proof display and input facility for allowing a user of the device both to receive a visual indication of shaves effected with a particular razor blade, and to input user commands to said device;
said base portion defining a razor nest for removably receiving a safety razor, and including a water-proof sensor facility for providing a non-contact input to said shave counting circuit in response to removal from or replacement into said nest of a safety razor.

4. A razor holder according to claim 3 wherein said shave counting circuit including a programmable microprocessor, and said microprocessor including programming to, on the one hand, learn during a programming mode of operation the number of good shaves a user can obtain from a safety razor blade, and on the other hand to, during a reminder mode of operation, to count the number of shaves the user has effected with a particular razor blade and signaling the user when the number of good shaves has been reached so that the razor blade can be replaced by the user.

5. A razor holder according to claim 3 wherein said water-proof sensor for providing non-contact input to said shave counting circuit includes a movable magnet.

6. A razor holder according to claim 5 wherein said shave counting circuit includes a magnetically-responsive switching device responding to movements of said movable magnet in order to count shaves effected with the safety razor.

7. A razor holder according to claim 6 wherein said magnetically-responsive switching device includes a magnetic reed switch.

8. A water-resistant razor holder having a learning shave counter, said razor holder comprising;
a base portion, said base portion internally defining a chamber for receiving a shave counting circuit, and including a water-proof display and input facility for allowing a user of the razor holder both to receive a visual indication of shaves effected with a particular razor blade, and to input user commands to said device;
said base portion defining a razor nest for removably receiving a safety razor, and including a water-proof sensor facility for providing a non-contact input to said shave counting circuit in response to removal from or replacement into said nest of a safety razor;
said shave counting circuit including a programmable microprocessor, and said microprocessor including programming to, on the one hand, learn during a learning mode of operation the number of good shaves a user can obtain from a safety razor blade; and during a reminder mode of operation, to count the number of shaves the user has effected with a particular razor blade and signaling the user when the number of good shaves has been reached so that the razor blade can be replaced by the user;
said water-proof sensor facility including a movable magnet, and said shave counting circuit including a magnetically-responsive switching device responding to movements of said movable magnet in order to count shaves effected with a safety razor.

9. A razor holder according to claim 8 wherein said magnetically-responsive switching device includes a magnetic reed switch.

10. A method of operating a device to first learn and then remind a consumer of the uses of a consumable item, said method comprising steps of:
during a learning mode of operation, counting the number of uses of a consumable item during a selected time interval or during its useful life;
during a reminder mode of operation, counting the number of uses of a consumable item during a time interval corresponding to said selected time interval, or during the useful life, and signaling a user when next to use the item or to replace the item at the end of its useful life.

11. The method of claim 10 wherein said method includes the steps of counting up the number of uses of a consumable item during its useful life

12. A water-resistant toothbrush holder having a learning counter and reminder for measuring the useful life of a toothbrush, said toothbrush holder comprising;
a base portion, said base portion defining a cavity for receiving a counting circuit, and including a water-proof display and input facility for allowing a user of the holder to both receive a visual indication of the number of tooth brushings effected with a particular toothbrush, and to input user commands to said holder;
said base portion defining a recess for removably receiving a toothbrush, and including a water-proof sensor facility for providing a non-contact input to said counting circuit in response to removal from or replacement into said recess of a toothbrush;
said counting circuit including a programmable microprocessor, and said microprocessor including programming to, on the one hand, learn during a learning mode of operation the number of tooth brushings a user effects with a particular tooth brush during its useful life; and during a reminder mode of operation, to count the number of tooth brushings the user has effected with a particular new tooth brush and signaling the user when the number of tooth brushings has been reached so that the tooth brush can be timely replaced by the user;
said water-proof sensor facility including a movable magnet, and said counting circuit including a magnetically-responsive switching device responding to movements of said movable magnet in order to count tooth brushings effected with a particular tooth brush.

13. A tooth brush holder according to claim 12 wherein said magnetically-responsive switching device includes a magnetic reed switch.

14. A pill bottle holder having a learning counter for on the one hand learning a users pill-taking schedule, and on the other hand for reminding a user to take a pill on time, said pill bottle holder comprising;
a base portion, said base portion internally defining a chamber for receiving a learning counter circuit, and including a water-proof display and input facility for allowing a user of the pill bottle holder both to receive an indication of pills taken, and to input user commands to said pill bottle holder;
said base portion defining a pill bottle receptacle for removably receiving a pill bottle, and including a water-proof sensor facility for providing a non-contact input to said counter circuit in response to removal from or replacement into said receptacle of a pill bottle;
said counter circuit including a programmable microprocessor, and said microprocessor including programming to, on the one hand, learn during a learning mode of operation the pill-taking schedule of a user; and during a reminder mode of operation, to count the number of pills taken by the user during a particular time interval as indicated by removal from and replacement into the receptacle of the pill bottle, and signaling the user when the next pill is to be taken;
said water-proof sensor facility including a movable magnet, and said counter circuit including a magnetically-responsive switching device responding to movements of said movable magnet in order to count movements of said pill bottle into and from said receptacle.

15. A pill bottle holder according to claim 14 wherein said magnetically-responsive switching device includes a magnetic reed switch.
